(19) United States
(12) Patent Application Publication
(10) Pub. No.: US 2022/0363559 A1
(43) Pub. Date: Nov. 17, 2022

(54) ENHANCED PROTON CONDUCTION AND STEAM TOLERANCE OF A DONOR DOPED ELECTROLYTE FOR SOLID OXIDE ELECTROLYSIS CELLS

(71) Applicants: Phillips 66 Company, Houston, TX (US); Georgia Tech Research Corporation, Atlanta, GA (US)

(72) Inventors: Zheyu Luo, Atlanta, GA (US); Yucun Zhou, Atlanta, GA (US); Ying Liu, Bartlesville, OK (US); Meilin Liu, Alpharetta, GA (US)

(21) Appl. No.: 17/745,200

(22) Filed: May 16, 2022

Related U.S. Application Data
(60) Provisional application No. 63/189,564, filed on May 17, 2021.

(51) Int. Cl. C01G 33/00; C25B 1/02; C01G 35/00

(52) U.S. Cl. CPC C01G 33/006; C25B 1/02; C01G 35/006; C01P 2006/40; C01P 2002/72

(57) ABSTRACT

Disclosed herein are electrolytes having increased proton conduction and steam tolerance for use in solid oxide electrolysis cells (SOECs). The disclosed SOECs provide an enhanced means for obtaining hydrogen. The disclosed SOECs provide enhanced conductivity and stability and, therefore, result in higher performance when used to fabricate electrolysis cells, fuel cells, and reversible cells.

### FIELD

Disclosed herein are electrolytes having increased proton conduction and steam tolerance for use in solid oxide electrolysis cells (SOECs). The disclosed SOEC's provide an enhanced means for obtaining hydrogen. The disclosed SOECs provide enhanced conductivity and stability and, therefore, result in higher performance when used to fabricate electrolysis cells, fuel cells, and reversible cells.

### BRIEF DESCRIPTION OF THE FIGURES

FIG. 1A and FIG. 1B depict the XRD patterns of different examples of the disclosed compounds.

FIG. 2A is a graph comparing the conductivity of prior art zirconium/yttrium-containing electrolyte, BaZr_{0.1}Ce_{0.7}Y_{0.1}Yb_{0.1}O_{3-δ} (BZCYYb) with various disclosed electrolytes in wet Ar (3 vol % water) at different temperatures.

FIG. 2B compares the conductivity of prior art zirconium/yttrium-containing electrolyte, BaZr_{0.1}Ce_{0.7}Y_{0.1}Yb_{0.1}O_{3-δ} (BZCYYb) and BTCYb with varying compositions and as a function of temperature.

FIG. 2C is a series of graphs comparing the conductivity of prior art zirconium/yttrium-containing electrolyte, BaZr_{0.1}Ce_{0.7}Y_{0.1}Yb_{0.1}O_{3-δ} (BZCYYb) with BaNb_{0.05}Ce_{0.7}Yb_{0.25}O_{3-δ} at different temperatures and partial pressures of oxygen, p_{O2}.

FIG. 3A depicts the conductivity versus temperature of BZCYYb versus various disclosed compounds having varying niobium (Nb) content in wet Ar (3 vol % water).

FIG. 3B depicts the conductivity versus temperature of BZCYYb versus various disclosed compounds having varying niobium (Nb) content and a disclosed compound wherein Nb is replaced by tantalum (Ta) in wet Ar (3 vol % water).

FIG. 4 compares the conductivity of BNCYb, BTCYb, and BZCYYb in wet Ar (3 vol % water) at 500 ° C. over 550 hours. FIG. 5A depicts the comparison of XRD patterns as it relates to the stability of a BaZr_{0.1}Ce_{0.7}Y_{0.1}Yb_{0.1}O_{3-δ} sample versus a BaNb_{0.05}Ce_{0.7}Yb_{0.25}O_{3-δ} sample in 30 vol % water/70 vol % argon at 500° C. after 550 hours.

FIG. 5B demonstrates the relative instability of BaZr_{0.1}Ce_{0.7}Y_{0.1}Yb_{0.1}O_{3-δ} versus BaNb_{0.05}Ce_{0.7}Yb_{0.25}O_{3-δ} wherein the BZCYYb sample shows a loss of Ba atoms in the form of Ba(OH)2*8H₂O.

FIG. 6A depicts XRD patterns of BNCYb05 samples with varying compositions after firing with NiO at 1400° C. for 5 hours.

FIG. 6B depicts XRD patterns of BTCYb05 samples with varying compositions after firing with NiO at 1400° C. for 5 hours.

FIG. 7A is a graph of conductivity versus partial pressure of water in pure argon at various temperatures for BZCYYb and BNCYb.

FIG. 7B is a graph of conductivity versus partial pressure of water in argon with 20 vol % oxygen at various temperatures for BZCYYb and BNCYb.

FIG. 8A depicts the XRD patterns of a powder mixture of BNCYb and NiO in a 1:1 ratio (top) and a powder mixture of BTCYb electrolyte and NiO in a 1:1 ratio (bottom) after each has been fired at 1400° C. for 5 hours.

FIG. 8B is a SEM image of the electrolyte surface of a Ni-BNCYb/BNCYb fuel electrode-supported half cell (electrolyte thickness=10 um) after firing at 1400° C. for 5 hours

FIG. 8C is an SEM image of the electrolyte surface of a Ni-BTCYb/BTCYb fuel electrode-supported half cell (electrolyte thickness=10 um) after firing at 1400° C. for 5 hours.

FIG. 8D is a Cross-sectional SEM image of the Ni-BTCYb/BTCYb/PBCC single cell.

FIG. 8E is an SEM of a Ni-BNCYb/BNCYb/PBCC single cell.

FIG. 9A depicts the cell performance of Ni-BNCYb/BaNb_{0.05}Ce_{0.7}Yb_{0.25}O_{3-δ}/PBCC under fuel cell operating conditions.

FIG. 9B depicts the performance of Ni-BZCYYb/BaZr_{0.1}Ce_{0.7}Y_{0.1}Yb_{0.1}O_{3-δ}/PBCC single cells under fuel cell operating conditions.

FIG. 10A depicts the cell performance of Ni-BNCYb/BaNb_{0.05}Ce_{0.7}Yb_{0.25}O_{3-δ}/PBCC under electrolysis cell operating conditions.

FIG. 10B depicts the performance Ni-BZCYYb/BaZr_{0.1}Ce_{0.7}Y_{0.1}Yb_{0.1}O_{3-δ}/PBCC single cells under electrolysis cell operating conditions.

FIG. 10C indicates the stability of a Ni-BNCYb/BNCYb/PBCC single cell fuel cell mode with H₂ (3% H₂O) in the fuel electrode and ambient air in the air electrode at 0.5 A cm⁻² and 650° C.

FIG. 10D indicates the reversible operation of a Ni-BNCYb/BNCYb/PBCC single cell fuel cell: the cell voltage as a function of time when the operating mode was switched between the fuel cell and electrolysis modes (2 h for each mode) at a current density of ±0.5 A cm⁻² and 650° C.,

FIG. 10E depicts a Ni-BNCYb/BNCYb/PBCC single cell fuel cell in electrolysis mode at 600° C. with H₂ (3% H₂O) in the fuel electrode and air (3% H₂O) in the air electrode at −1 A cm⁻², and with H₂ (3% H₂O) in the fuel electrode and air (30% H₂O) in the air electrode at −0.5 A cm⁻².

FIG. 10F depicts a Ni-BNCYb/BNCYb/PBCC single cell fuel cell electrolysis mode with H₂ (3% H₂O) in the fuel electrode and air (3% H₂O) in the air electrode at −0.5 A cm⁻² and 500° C. for 800 hours.

FIG. 11A depicts the conductivity of BNCYb057025 as a function of temperature under various atmospheres.

FIG. 11B depicts the conductivity of BTCYb057025 as a function of temperature under various atmospheres.

FIG. 12 depicts the full view of XRD patterns of BNCYb, BTCYb, and BZCYYb pellets after exposure to 30% CO₂ and 3% H₂O in Ar at 500° C. for 300 hours.

FIG. 13A depicts the XRD pattern of BNCYb after calcining with PBCC at 1000° C. for 4 hours.

FIG. 13B depicts the XRD pattern of BTCYb after calcining with PBCC at 1000° C. for 4 hours. FIG. 14A shows a typical I-V-P curves measured in the fuel cell mode at 500-650° C. with H₂ (3% H₂O) in the fuel electrode and ambient air in the air electrode in the air electrode of the Ni-BTCYb/BTCYb/PBCC single cell.

FIG. 14B shows a typical I-V curves measured in the electrolysis mode at 500-650° C. with H₂ (3% H₂O) in the fuel electrode and air (30% H₂O) in the air electrode of the Ni-BTCYb/BTCYb/PBCC single cell.

FIG. 15A stows the long-term stability of the Ni-BTCYb/BTCYb/PBCC single cell in) fuel cell mode with H₂ (3% H₂O) in the fuel electrode and ambient air in the air electrode at 0.5 A cm⁻² and 650° C.

FIG. 15B shows the long-term stability of the Ni-BTCYb/BTCYb/PBCC single cell in the electrolysis mode with H₂ (3% H₂O) in the fuel electrode and air (30% H₂O) in the air electrode at −1 A cm⁻² and 600° C.

### DETAILED DESCRIPTION

The materials, compounds, compositions, articles, and methods described herein may be understood more readily by reference to the following detailed description of specific aspects of the disclosed subject matter and the Examples included therein.

Before the present materials, compounds, compositions, and methods are disclosed and described, it is to be understood that the aspects described below are not limited to specific synthetic methods or specific reagents, as such may, of course, vary. It is also to be understood that the terminology used herein is for the purpose of describing particular aspects only and is not intended to be limiting.

Also, throughout this specification, various publications are referenced. The disclosures of these publications in their entireties are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

### General Definitions

In this specification and in the claims that follow, reference will be made to a number of terms, which shall be defined to have the following meanings:

All percentages, ratios and proportions herein are by weight, unless otherwise specified. All temperatures are in degrees Celsius (⁰ C) unless otherwise specified.

The terms “a” and “an” are defined as one or more unless this disclosure explicitly requires otherwise.

Ranges may be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

Values expressed as “greater than” do not include the lower value. For example, when the “variable x” is defined as “greater than zero” expressed as “0<x” the value of x is any value, fractional or otherwise that is greater than zero.

Similarly, values expressed as “less than” do not include the upper value. For example, when the “variable x” is defined as “less than 2” expressed as “x<2” the value of x is any value, fractional or otherwise that is less than 2.

“Optional” or “optionally” means that the subsequently described event or circumstance can or cannot occur, and that the description includes instances where the event or circumstance occurs and instances where it does not.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, an apparatus that “comprises,” “has,” “includes” or “contains” one or more elements possesses those one or more elements, but is not limited to possessing only those elements. Likewise, a method that “comprises,” “has,” “includes” or “contains” one or more steps possesses those one or more steps, but is not limited to possessing only those one or more steps.

Any embodiment of any of the apparatuses, systems, and methods can consist of or consist essentially of—rather than comprise/include/contain/have—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb.

The feature or features of one embodiment may be applied to other embodiments, even though not described or illustrated, unless expressly prohibited by this disclosure or the nature of the embodiments.

Any embodiment of any of the apparatuses, systems, and methods can consist of or consist essentially of—rather than comprise/include/contain/have—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb.

The terms “solid oxide electrolysis cell”, “solid oxide electrolytic cell”, “SOEC”, and “compound” are used interchangeably throughout the disclosure.

The feature or features of one embodiment may be applied to other embodiments, even though not described or illustrated, unless expressly prohibited by this disclosure or the nature of the embodiments.

Details associated with the embodiments described above and others are described below.

### Compounds

Disclosed herein are compounds when used in solid oxide electrolysis cells (SOECs) provide an advantage over existing electrolytes due to their high efficiency and stability when producing sources of clean energy. In addition, when used in reversible electrochemical cells that can operate as both fuel cells and under electrolysis conditions, the disclosed electrolytes possess the capability to efficiently convert fuel to energy or vice versa. Therefore, the use of the disclosed electrolytes provides a means for producing green energy sources, such as hydrogen, in a more cost-effective manner than other currently available technologies.

In the past, the commercial application of solid oxide electrolytic cells has been hampered by the sluggish conductivity of the ion conducting electrolytes that comprise these cells. In addition, there is a high degree of instability by state-of-the-art electrolytes against high concentrations of water even at intermediate temperatures (˜500° C.). The disclosed electrolytes exhibit high ionic conductivity while producing limited electronic conductivity. In addition, the disclosed electrolytes demonstrate chemical stability against various contaminants and are compatible with various electrode materials.

For example, a current mixed ion conductor BaZr_{0.1}Ce_{0.7}Y_{0.1}Yb_{0.1}O_{3-δ} (BZCYYb) has been widely used as an electrolyte material, but its instability against high concentration of steam makes it unsuitable for long term operation at intermediate temperatures with high water partial pressure. Another electrolyte in current use, the donor doped barium-cerate, BaCe_{1-x-y}ZrₓNb_{y}O_{3+δ} (BCZN), exhibits excellent chemical stability, however, its conductivity is relatively low at intermediate temperatures due to the incorporation of a donor dopant. In spite of these drawbacks, barium-cerate and barium-zirconate based materials are still the most widely used electrolytes for SOECs.

The disclosed electrolytes suitable for use in solid oxide electrolysis cells, have the formula:

BaMₓCe_{1-x-y}R_{y}O_{3-δ}

wherein M is niobium or tantalum; R is one or more metals having a valence of 3⁺. Non-limiting examples of metals having a 3⁺ valence include ytterbium, yttrium, dysprosium, scandium, vanadium, chromium, iron, cobalt, lutetium, holmium, terbium and the like.

One aspect of the disclosed electrolytes comprise niobium (M=Nb). In one iteration of this aspect R is ytterbium (Yb). In a further iteration of this aspect R is yttrium (Y). In another iteration of this aspect R is dysprosium (Dy). In a still further iteration of this aspect R is an element having a 3⁺ valence.

In another aspect of the disclosed electrolytes comprise tantalum (M=Ta). In one iteration of this aspect R is ytterbium (Yb). In a further iteration of this aspect R is yttrium (Y). In another iteration of this aspect R is dysprosium (Dy). In a still further iteration of this aspect R is an element having a 3⁺ valence.

The index x is from 0 to 1. For example, the index x can be 0.01, 0.011, 0.012, 0.013, 0.014, 0.015, 0.016, 0.017, 0.018, 0.019, 0.02, 0.021, 0.022, 0.023, 0.024, 0.025, 0.026, 0.027, 0.028, 0.029, 0.03, 0.031, 0.032, 0.033, 0.034, 0.035, 0.036, 0.037, 0.038, 0.039, 0.04, 0.041, 0.042, 0.043, 0.044, 0.045, 0.046, 0.047, 0.048, 0.049, 0.05, 0.051, 0.052, 0.053, 0.054, 0.055, 0.056, 0.057, 0.058, 0.059, 0.06, 0.061, 0.062, 0.063, 0.064, 0.065, 0.066, 0.067, 0.068, 0.069, 0.07, 0.071, 0.072, 0.073, 0.074, 0.075, 0.076, 0.077, 0.078, 0.079, 0.08, 0.081, 0.082, 0.083, 0.084, 0.085, 0.086, 0.087, 0.088, 0.089, 0.09, 0.091, 0.092, 0.093, 0.094, 0.095, 0.096, 0.097, 0.098, 0.099, 0.1, 0.11, 0.12, 0.13, 0.14, 0.15, 0.16, 0.17, 0.18, 0.19, 0.2, 0.21, 0.22, 0.23, 0.24, 0.25, 0.26, 0.27, 0.28, 0.29, 0.3, 0.31, 0.32, 0.33, 0.34, 0.35, 0.36, 0.37, 0.38, 0.39, 0.4, 0.41, 0.42, 0.43, 0.44, 0.45, 0.46, 0.47, 0.48, 0.49, 0.5, 0.51, 0.52, 0.53, 0.54, 0.55, 0.56, 0.57, 0.58, 0.59, 0.6, 0.61, 0.62, 0.63, 0.64, 0.65, 0.66, 0.67, 0.68, 0.69, 0.7, 0.71, 0.72, 0.73, 0.74, 0.75, 0.76, 0.77, 0.78, 0.79, 0.8, 0.81, 0.82, 0.83, 0.84, 0.85, 0.86, 0.87, 0.88, 0.89, 0.9, 0.91, 0.92, 0.93, 0.94, 0.95, 0.96, 0.97, 0.98, 0.99, or 1.

The index y is from 0 to 1. For example, the index y can be 0.01, 0.011, 0.012, 0.013, 0.014, 0.015, 0.016, 0.017, 0.018, 0.019, 0.02, 0.021, 0.022, 0.023, 0.024, 0.025, 0.026, 0.027, 0.028, 0.029, 0.03, 0.031, 0.032, 0.033, 0.034, 0.035, 0.036, 0.037, 0.038, 0.039, 0.04, 0.041, 0.042, 0.043, 0.044, 0.045, 0.046, 0.047, 0.048, 0.049, 0.05, 0.051, 0.052, 0.053, 0.054, 0.055, 0.056, 0.057, 0.058, 0.059, 0.06, 0.061, 0.062, 0.063, 0.064, 0.065, 0.066, 0.067, 0.068, 0.069, 0.07, 0.071, 0.072, 0.073, 0.074, 0.075, 0.076, 0.077, 0.078, 0.079, 0.08, 0.081, 0.082, 0.083, 0.084, 0.085, 0.086, 0.087, 0.088, 0.089, 0.09, 0.091, 0.092, 0.093, 0.094, 0.095, 0.096, 0.097, 0.098, 0.099, 0.1, 0.11, 0.12, 0.13, 0.14, 0.15, 0.16, 0.17, 0.18, 0.19, 0.2, 0.21, 0.22, 0.23, 0.24, 0.25, 0.26, 0.27, 0.28, 0.29, 0.3, 0.31, 0.32, 0.33, 0.34, 0.35, 0.36, 0.37, 0.38, 0.39, 0.4, 0.41, 0.42, 0.43, 0.44, 0.45, 0.46, 0.47, 0.48, 0.49, 0.5, 0.51, 0.52, 0.53, 0.54, 0.55, 0.56, 0.57, 0.58, 0.59, 0.6, 0.61, 0.62, 0.63, 0.64, 0.65, 0.66, 0.67, 0.68, 0.69, 0.7, 0.71, 0.72, 0.73, 0.74, 0.75, 0.76, 0.77, 0.78, 0.79, 0.8, 0.81, 0.82, 0.83, 0.84, 0.85, 0.86, 0.87, 0.88, 0.89, 0.9, 0.91, 0.92, 0.93, 0.94, 0.95, 0.96, 0.97, 0.98, 0.99, or 1.

For compounds wherein two or more metals having a valence of 3+ comprise R, for example, BaNb_{0.05}Ce_{0.7}Y_{0.05}Yb_{0.2}O_{3-δ}, wherein R=Y and Yb, the sum of the individual y indices is from 0 to 1.

Non-limiting examples of electrolytes comprising niobium include:

| | | |
|---|---|---|
| BaNb_{0.05}Ce_{0.75}Yb_{0.2}O_{3-δ} | BaNb_{0.05}Ce_{0.75}Y_{0.2}O_{3-δ} | BaNb_{0.05}Ce_{0.75}Dy_{0.2}O_{3-δ} |
| BaNb_{0.05}Ce_{0.7}Yb_{0.25}O_{3-δ} | BaNb_{0.05}Ce_{0.7}Y_{0.25}O_{3-δ} | BaNb_{0.05}Ce_{0.7}Dy_{0.25}O_{3-δ} |
| BaNb_{0.05}Ce_{0.65}Yb_{0.3}O_{3-δ} | BaNb_{0.05}Ce_{0.65}Y_{0.3}O_{3-δ} | BaNb_{0.05}Ce_{0.65}Dy_{0.3}O_{3-δ} |
| BaNb_{0.05}Ce_{0.6}Yb_{0.35}O_{3-δ} | BaNb_{0.05}Ce_{0.6}Y_{0.35}O_{3-δ} | BaNb_{0.05}Ce_{0.6}Dy_{0.35}O_{3-δ} |
| BaNb_{0.05}Ce_{0.55}Yb_{0.4}O_{3-δ} | BaNb_{0.05}Ce_{0.55}Y_{0.4}O_{3-δ} | BaNb_{0.05}Ce_{0.55}Dy_{0.4}O_{3-δ} |
| BaNb_{0.05}Ce_{0.5}Yb_{0.45}O_{3-δ} | BaNb_{0.05}Ce_{0.5}Y_{0.45}O_{3-δ} | BaNb_{0.05}Ce_{0.5}Dy_{0.45}O_{3-δ} |
| BaNb_{0.1}Ce_{0.6}Yb_{0.3}O_{3-δ} | BaNb_{0.1}Ce_{0.6}Y_{0.3}O_{3-δ} | BaNb_{0.1}Ce_{0.6}Dy_{0.3}O_{3-δ} |
| BaNb_{0.2}Ce_{0.4}Yb_{0.4}O_{3-δ} | BaNb_{0.2}Ce_{0.4}Y_{0.4}O₃₋₈ | BaNb_{0.2}Ce_{0.4}Dy_{0.4}O_{3-δ} |
| BaNb_{0.05}Ce_{0.7}Y_{0.05}Yb_{0.2}O_{3-δ} | BaNb_{0.05}Ce_{0.7}Y_{0.1}Yb_{0.15}O_{3-δ} | BaNb_{0.05}Ce_{0.7}Dy_{0.05}Yb_{0.2}O_{3-δ} |
| BaNb_{0.05}Ce_{0.65}Y_{0.05}Yb_{0.25}O_{3-δ} | BaNb_{0.05}Ce_{0.65}Y_{0.1}Yb_{0.2}O_{3-δ} | BaNb_{0.05}Ce_{0.65}Dy_{0.05}Yb_{0.25}O_{3-δ} |
| BaNb_{0.05}Ce_{0.6}Y_{0.05}Yb_{0.3}O_{3-δ} | BaNb_{0.05}Ce_{0.6}Y_{0.1}Yb_{0.25}O_{3-δ} | BaNb_{0.05}Ce_{0.6}Dy_{0.05}Yb_{0.3}O_{3-δ} |
| BaNb_{0.1}Ce_{0.6}Y_{0.05}Yb_{0.25}O_{3-δ} | BaNb_{0.1}Ce_{0.6}Y_{0.1}Yb_{0.2}O_{3-δ} | BaNb_{0.1}Ce_{0.6}Dy_{0.05}Yb_{0.25}O_{3-δ} |
| BaNb_{0.2}Ce_{0.4}Y_{0.05}Yb_{0.35}O_{3-δ} | BaNb_{0.2}Ce_{0.4}Y_{0.1}Yb_{0.3}O_{3-δ} | BaNb_{0.2}Ce_{0.4}Dy_{0.05}Yb_{0.35}O_{3-δ} |

Non-limiting examples of electrolytes comprising tantalum include:

| | | |
|---|---|---|
| BaTa_{0.05}Ce_{0.75}Yb_{0.2}O_{3-δ} | BaTa_{0.05}Ce_{0.75}Y_{0.2}O_{3-δ} | BaTa_{0.05}Ce_{0.75}Dy_{0.2}O_{3-δ} |
| BaTa_{0.05}Ce_{0.7}Yb_{0.25}O_{3-δ} | BaTa_{0.05}Ce_{0.7}Y_{0.25}O_{3-δ} | BaTa_{0.05}Ce_{0.7}Dy_{0.25}O_{3-δ} |
| BaTa_{0.05}Ce_{0.65}Yb_{0.3}O_{3-δ} | BaTa_{0.05}Ce_{0.65}Y_{0.3}O_{3-δ} | BaTa_{0.05}Ce_{0.65}Dy_{0.3}O_{3-δ} |
| BaTa_{0.05}Ce_{0.6}Yb_{0.35}O_{3-δ} | BaTa_{0.05}Ce_{0.6}Y_{0.35}O_{3-δ} | BaTa_{0.05}Ce_{0.6}Dy_{0.35}O_{3-δ} |
| BaTa_{0.05}Ce_{0.55}Yb_{0.4}O_{3-δ} | BaTa_{0.05}Ce_{0.55}Y_{0.4}O_{3-δ} | BaTa_{0.05}Ce_{0.55}Dy_{0.4}O_{3-δ} |
| BaTa_{0.05}Ce_{0.5}Yb_{0.45}O_{3-δ} | BaTa_{0.05}Ce_{0.5}Y_{0.45}O_{3-δ} | BaTa_{0.05}Ce_{0.5}Dy_{0.45}O_{3-δ} |
| BaTa_{0.1}Ce_{0.6}Yb_{0.3}O_{3-δ} | BaTa_{0.1}Ce_{0.6}Y_{0.3}O_{3-δ} | BaTa_{0.1}Ce_{0.6}Dy_{0.3}O_{3-δ} |
| BaTa_{0.05}Ce_{0.7}Y_{0.05}Yb_{0.2}O_{3-δ} | BaTa_{0.05}Ce_{0.7}Y_{0.1}Yb_{0.15}O_{3-δ} | BaTa_{0.05}Ce_{0.7}Dy_{0.05}Yb_{0.2}O_{3-δ} |
| BaTa_{0.05}Ce_{0.65}Y_{0.05}Yb_{0.25}O_{3-δ} | BaTa_{0.05}Ce_{0.65}Y_{0.1}Yb_{0.2}O_{3-δ} | BaTa_{0.05}Ce_{0.65}Dy_{0.05}Yb_{0.25}O_{3-δ} |
| BaTa_{0.05}Ce_{0.6}Y_{0.05}Yb_{0.3}O_{3-δ} | BaTa_{0.05}Ce_{0.6}Y_{0.1}Yb_{0.25}O_{3-δ} | BaTa_{0.05}Ce_{0.6}Dy_{0.05}Yb_{0.3}O_{3-δ} |
| BaTa_{0.1}Ce_{0.6}Y_{0.05}Yb_{0.25}O_{3-δ} | BaTa_{0.1}Ce_{0.6}Y_{0.1}Yb_{0.2}O_{3-δ} | BaTa_{0.1}Ce_{0.6}Dy_{0.05}Yb_{0.25}O_{3-δ} |

The disclosed electrolytes exhibit high ionic conductivity, excellent stability against high concentration of water, and good chemical compatibility with electrode materials. Without wishing to be limited by theory, the excellent stability was achieved by Nb doping and the high conductivity was achieved by heavy Yb doping. The BNCYb electrolyte pellet demonstrated excellent stability under high humidity (30 vol % H₂O) at 500° C. for over 550 hours, while its conductivity is comparable to that of BZCYYb. In the electrolysis mode, a single cell with a configuration of Ni-BNCYb|BNCYb|PBCC showed a current density of 1.8 A cm⁻² at an applied voltage of 1.3V at 600° C. Under fuel cell operating conditions, the BNCYb-based cells achieved a peak power density of ˜1 W/cm² at 600° C., which is better than that of the cell based on BZCYYb electrolyte.

### Electrolyte Synthesis

BNCYb, BTCYB, and other disclosed electrolyte powders were synthesized using a solid-state reaction process. Appropriate mole ratios of metal oxides and metal carbonates were well mixed by ball milling in ethanol for 24 hours, followed by drying and calcination at 1100° C. for 10 hours. The ball milling process was repeated twice to obtain the desired phase. The calcined powder was further pressed into pellets and fired at 1450° C. for 5 hours with the addition of 1 wt % NiO and PVB as sintering aid and binder, respectively. The green disks had a diameter of 10 mm, with a typical thickness of 0.8 mm.

### Electrochemical Measurements

To measure the conductivity, silver electrodes were affixed to the samples with silver paste and fired to 800° C. for 1 hour. The conductivity was measured using an EG&G 263A potentiostat and a Solartron SI1255 frequency response analyzer. The conductivity was measured under wet argon (3 vol % H₂O) atmosphere from 400 to 700° C. by impedance spectroscopy.

### Fabrication of Symmetrical Cells and Single Cells

Half cells with the configuration of Ni-BNCYb anode supporting layer, Ni-BNCYb anode functional layer, and BNCYb electrolyte layer were fabricated by the co-tape casting and co-sintering techniques. Specifically, the BNCYb electrolyte powder and the mixture of BNCYb and NiO powder (NiO:electrolyte powder=6:4 by weight) were mixed in solvent to form their respective slurries. The slurries for tape casting were ethanol based and contained dispersing agent, binder, plasticizer, and other additives, in addition to powder. The electrolyte layer was cast onto the Mylar film first. After drying, the anode functional layer was cast on top of the electrolyte layer, followed by the anode supporting layer. The tri-layer tape was then dried and co-sintered at 1400° C. for 5 h in air. A PrBa_{0.8}Ca_{0.2}Co₂O_{5+δ} (PBCC) cathode with an effective area of 0.28 cm² was prepared by screen printing the mixture of PBCC powder and terpineol (5 wt % ethyl cellulose) onto the electrolyte layer and fired at 950° C. for 2 hours in air. The PBCC powder was synthesized by a combustion method. Stoichiometric amounts of Pr(NO₃)₂.6H₂O, Ba(NO₃)₂, Ca(NO₃)₂.4H₂O, and Co(NO₃)₂.6H₂O were dissolved in distilled water with proper amount of ethylene glycol and anhydrous citric acid (1:1 ratio). The solutions were heated up to 350° C. in air and followed by combustion to form fine powders. The resulting powders were then ground and calcined again at 900° C. for 2 h. The button cells were mounted on an alumina supporting tube using Ceramabond 552 (Aremco) as sealant for electrochemical performance testing. The flow rate of the humidified H₂ (3 vol % H₂O) supplied to the fuel electrode was 20 sccm and the air electrode was exposed to ambient air (the oxidant). For the water electrolysis test, the flow rate of the humidified (3 vol % H₂O) H₂ and the humidified (3 vol % H₂O) air was 50 and 100 sccm, respectively. The cell performance was monitored using an Arbin multichannel electrochemical testing system (MSTAT).

### Other Characterizations

X-ray diffraction measurements were taken on a Panalytical X'Pert Pro Alpha-1 using CuKα1 radiation and a XCelerator detector in the range of 20-80 20. The cross-sectional microstructure and morphology of full cells were examined using a SEM (Hitachi SU8230)

The disclosed niobium doped materials, for example, as BCZN show excellent chemical stability against contaminants, which makes them good candidates as electrolyte materials for SOFCs. Due to the introduction of Nb, however, the conductivity of these materials is much lower than the state-of-the-art BZCYYb electrolyte. To increase conductivity, excess amount of trivalent dopant was introduced to create heavily doped BNCYb.

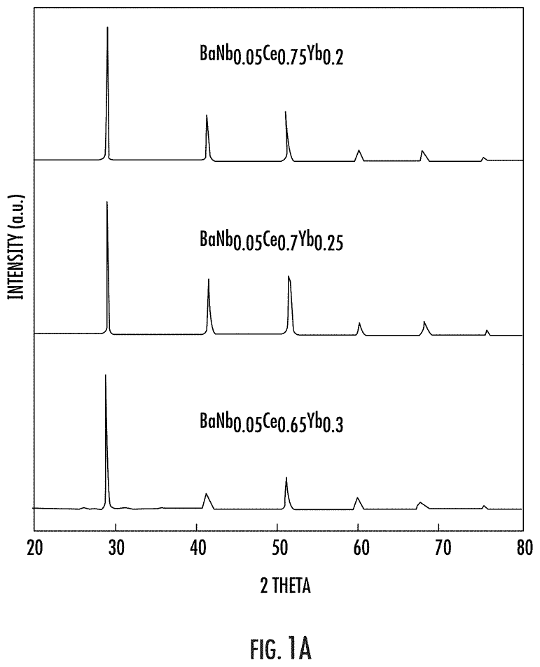

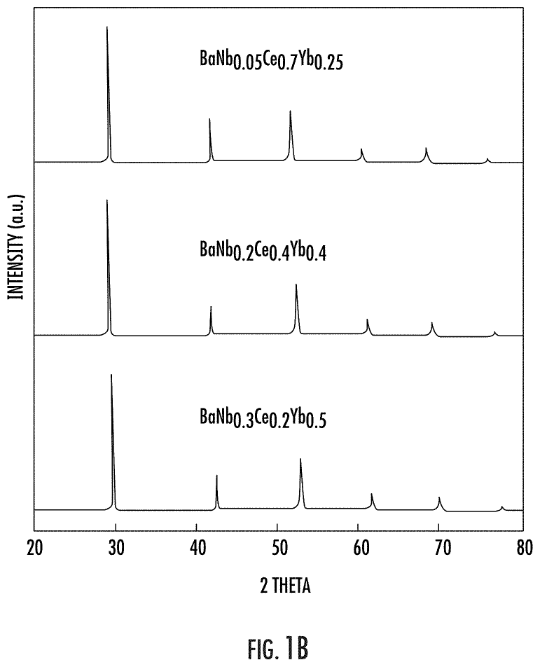

FIG. 1A and FIG. 1B show XRD patterns of BNCYb samples with varying compositions, all as-sintered samples have a single-phase cubic perovskite structure.

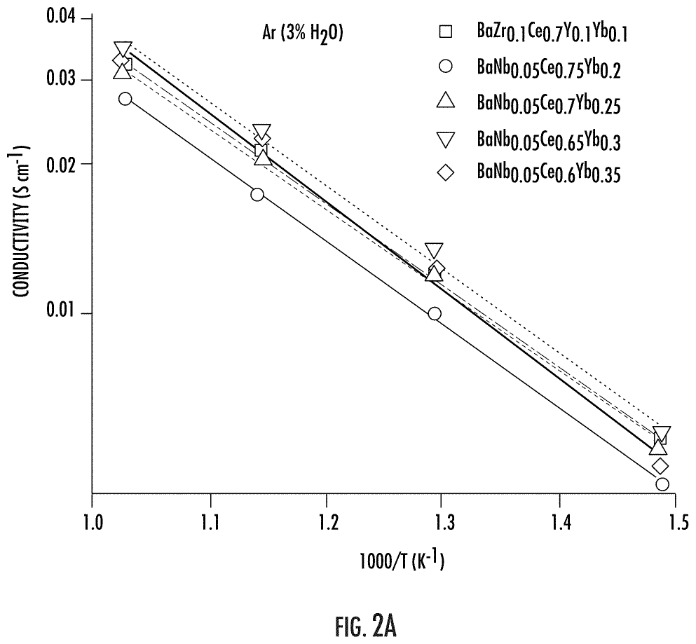

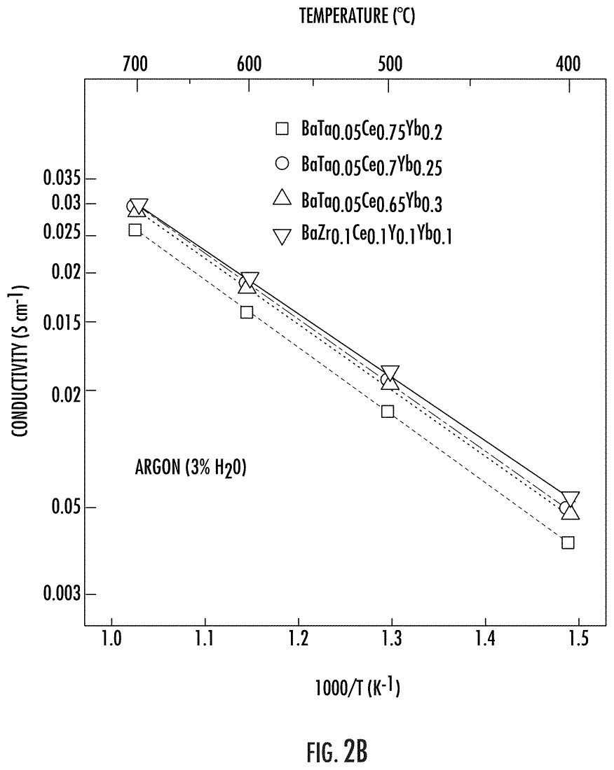

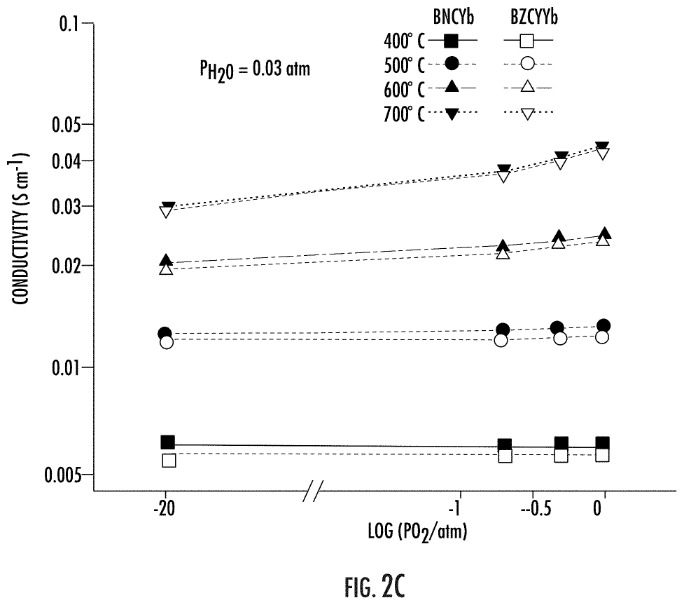

As shown in FIG. 2A, is the comparison of the conductivity of BNCYb with different levels of Yb doping. In the classical barium-cerate and barium-zirconate systems, the optimum concentration of trivalent dopant is well documented to be ˜20%, and conductivity should drop dramatically upon further doping. Without wishing to be limited by theory, as indicated in FIG. 2A the conductivity of BaNb_{0.05}Ce_{0.75}Yb₂O_{3-δ}, however, is much lower than BaNb_{0.5}Ce_{0.7}Yb_{0.25}O_{3-δ}, likely due to the lack of oxygen vacancy. After heavy doping, the conductivity of BaNb_{0.5}Ce_{0.7}Yb_{0.25}O_{3-δ} becomes comparable to that of BZCYYb, reaching around 0.012 S cm⁻¹ at 500° C. in wet argon. In addition, the conductivity remains fairly constant as the Yb content is increased.

FIG. 2B shows the conductivity of BTCYb05 samples with varying levels of Yb doping as a function of temperature. The conductivity of BaTa_{0.5}Ce_{0.75}Yb_{0.2}O_{3-δ} is much lower than BaNb_{0.5}Ce_{0.7}Yb_{0.25}O_{3-δ}, likely due to the lack of oxygen vacancy. After heavy doping, the conductivity of BaNb_{0.05}Ce_{0.7}Yb_{0.25}O_{3-δ} becomes comparable to that of BZCYYb, reaching around 0.012 S cm⁻¹ at 500° C. in wet argon.

Similar to BZCYYb, the conductivity of BNCYb becomes higher with increasing partial pressure of oxygen, suggesting BNCYb is a p-type mixed conductor. FIG. 2C illustrates the dependence of conductivity with pₒ₂, where the conductivity remains almost unchanged at all pot when the temperature is lower than 500° C., suggesting nearly pure ionic conduction at intermediate temperatures.

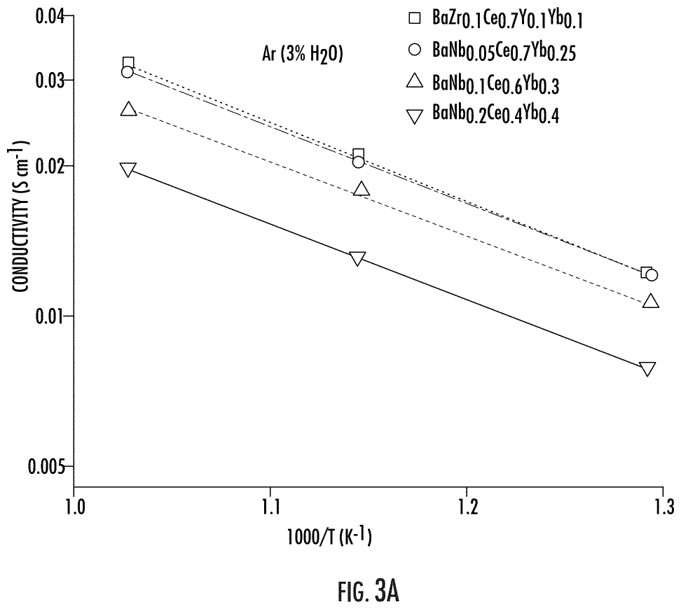

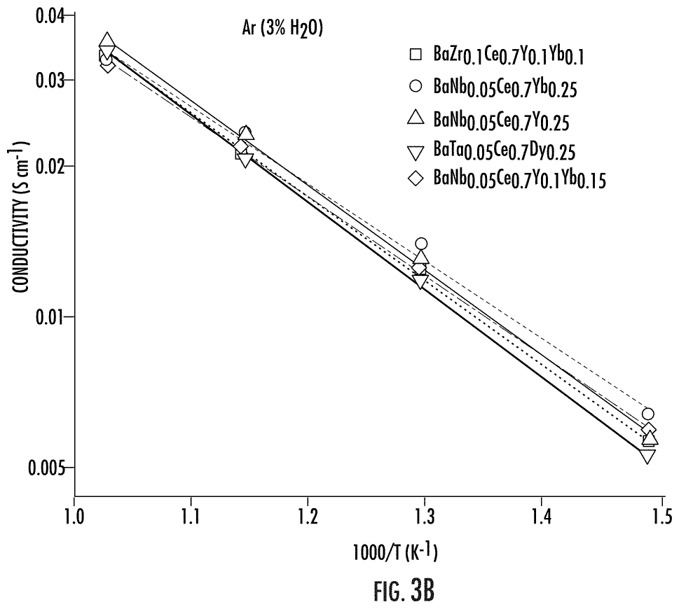

FIG. 3A shows that the conductivity decreases with increasing Nb content, which is similar to known barium-zirconate systems. As shown in FIG. 3B, Ta doped, other rare earth metal doped, and co-doped samples were investigated, and they all showed similar conductivity to BNCYb.

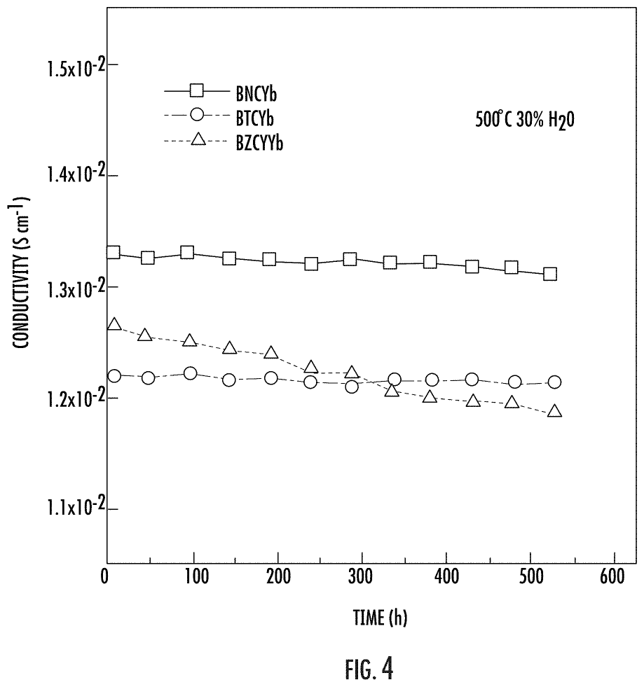

While BNCYb has comparable conductivity to that of BZCYYb and BTCYb, its stability against high concentration of steam is much better. FIG. 4 shows there is no degradation in terms of conductivity found for BNCYb when exposed to 30% H₂O at 500° C. for 550 hours, while the conductivity of BTCYb and BZCYYb decreased about 3.2%. Without wishing to be limited by theory, the electronegativity of Nb is much higher than Zr, which increases the acidity of the lattice and stabilizes the material. Nb tends to segregate to the surface after high temperature sintering, resulting in the formation of Nb-enriched surface, which enhances the stability (See, Gore et al., (2014). Journal of Materials Chemistry A, 2(7), 2363-2373).

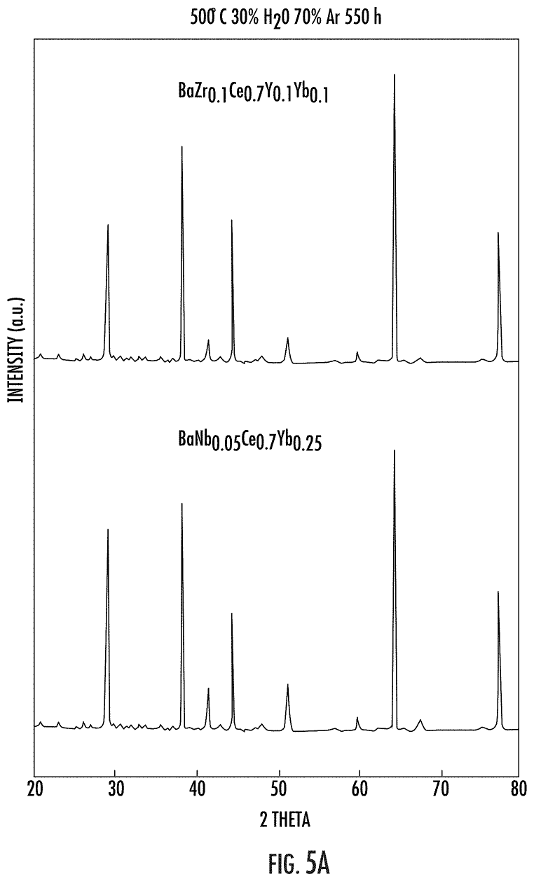

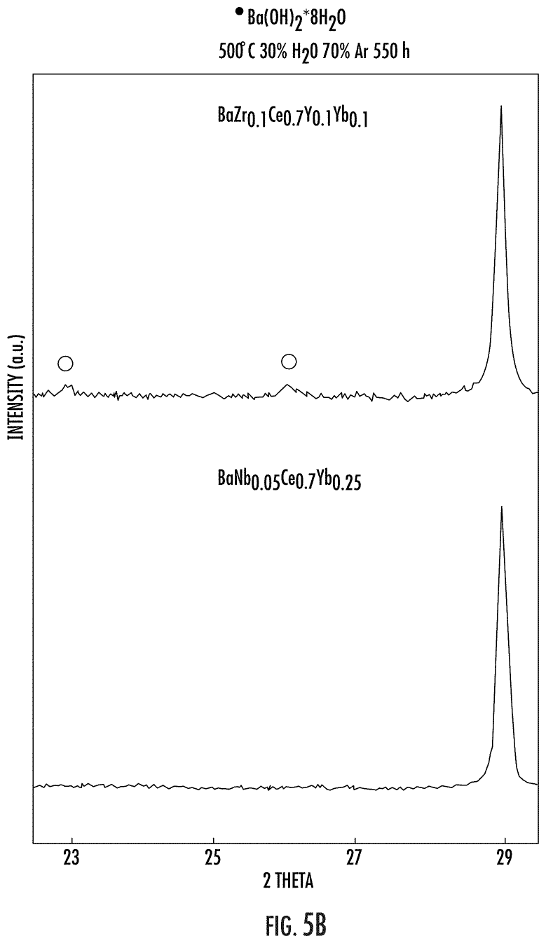

After the long term stability test, both materials were characterized by XRD, and Ba(OH)₂*8H₂O was identified on BZCYYb pellet but not on BNCYb. FIG. 5A depicts the comparison of XRD patterns as it relates to the stability of a BaZr_{0.1}Ce_{0.7}Y_{0.1}Yb_{0.1}O_{3-δ} sample versus a BaNb_{0.05}Ce_{0.7}Yb_{0.25}O_{3-δ} sample in 30 vol % water/70 vol % argon at 500° C. after 550 hours. FIG. 5B demonstrates the relative instability of BaZr_{0.1}Ce_{0.7}Y_{0.1}Yb_{0.1}O_{3-δ} versus BaNb_{0.5}Ce_{0.7}Yb_{0.25}O_{3-δ} wherein the BZCYYb sample shows a loss of Ba atoms in the form of Ba(OH)₂*8H₂O. The XRD refinement suggests the amount of degradation phases is about 15%. Those degradation phases were likely only on the surface of BZCYYb, and most of the bulk material was not contaminated, leading to only 3.2% degradation in conductivity.

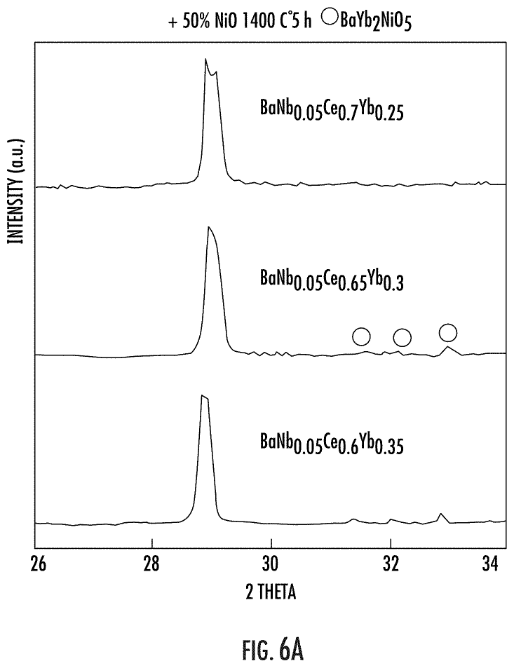

FIG. 6A depicts XRD patterns of BTCYb05 samples with varying compositions after firing with NiO at 1400° C. for 5 hours and FIG. 6B depicts XRD patterns of BTCYb05 samples with varying compositions after firing with NiO at 1400° C. for 5 hours. Although 25 and 30% Yb-doped BNCYb/BTCYb05 samples show comparable conductivity, the maximum doping concentration of Yb on the B-site is around 25% before the materials start to react with NiO and produce secondary phase BaYb₂NiO₅.

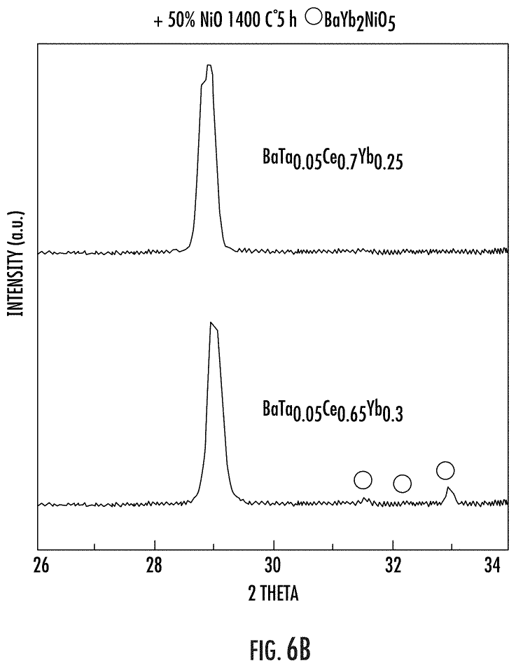

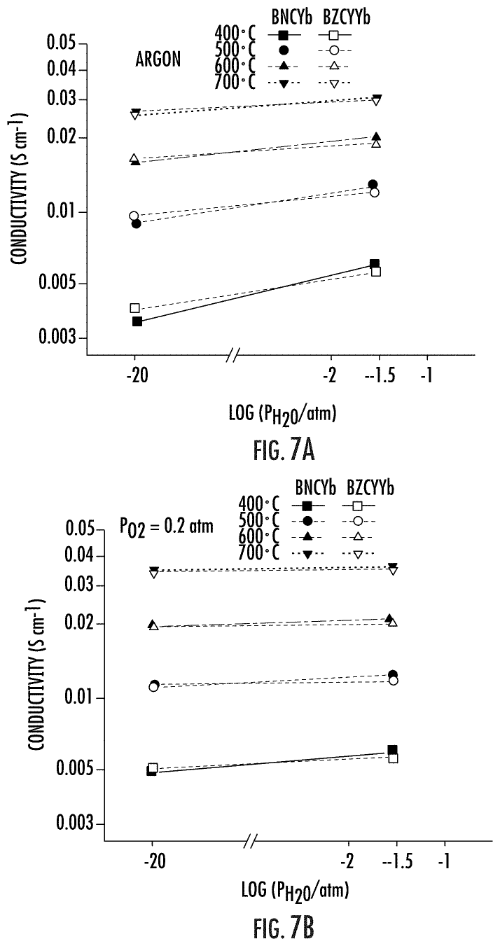

As seen in FIG. 7A BNCYb has better hydration capability than BZCYYb, while the conductivity of BNCYb is lower than BZCYYb in dry conditions, the conductivity of BNCYb as shown in FIG. 7B becomes comparable or slightly higher than BZCYYb upon introduction of H₂O.

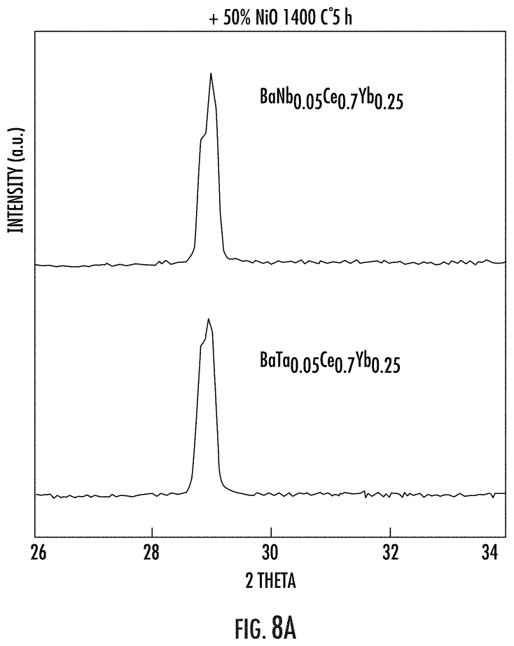

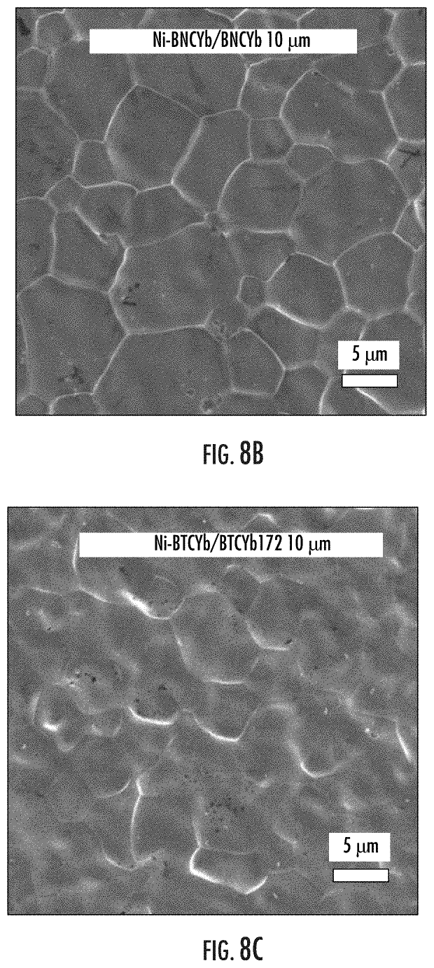

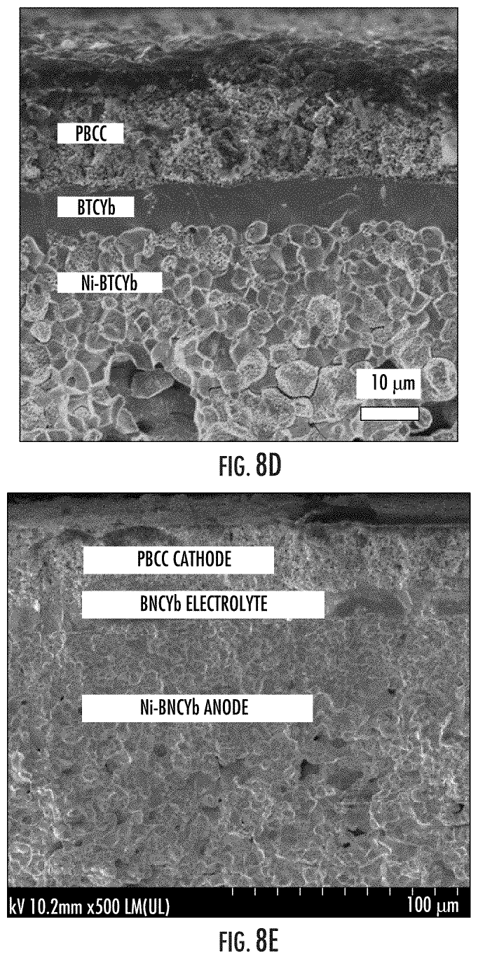

The compatibility between electrolyte materials and NiO is important for its practical application in fuel cells, as different components of the cell could easily react at high temperature (˜1400° C.). FIG. 8A depicts the XRD patterns of a powder mixture of BNCYb and NiO in a 1:1 ratio (top) and a powder mixture of BTCYb electrolyte and NiO in a 1:1 ratio (bottom) after each has been fired at 1400° C. for 5 hours. FIG. 8B is an SEM image of the top electrolytic surface of a BaNb_{0.05}Ce_{0.7}Yb_{0.25}O_{3-δ} anode-supported half-cell. FIG. 8C is an SEM image of the top electrolytic surface of a BaTa_{0.05}Ce_{0.7}Yb_{0.25}O_{3-δ} anode-supported half-cell. FIG. 8A, FIG. 8B, and FIG. 8C confirm the compatibility between BNCYb/BTCYb and NiO after co-sintering. No secondary phase was observed by XRD and SEM after co-firing. As shown in FIG. 8D, the cross-sectional SEM image of BNCYb-based full cell reveals a dense electrolyte layer with a thickness around 12 micron, and good bonding with porous electrodes. FIG. 8E is a Cross-sectional SEM image of the Ni-BTCYb/BTCYb/PBCC single cell.

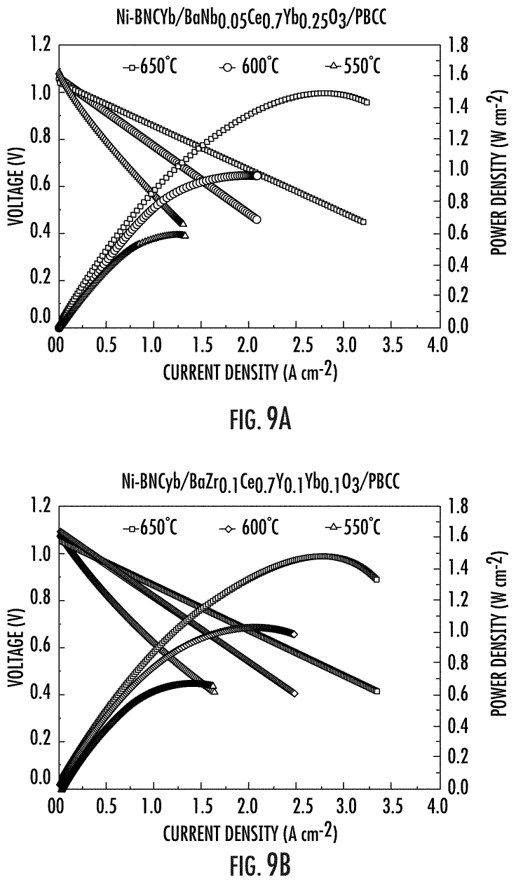

As depicted in FIG. 9A and FIG. 9B the single cell performance of BNCYb and BZCYYb in fuel cell operating conditions. It is important to note that the OCV of BNCYb-based cells is comparable to that of BZCYYb-based counterparts, suggesting limited electronic leakage of the electrolyte under fuel cell operating conditions. BNCYb outperforms BZCYYb in fuel cell mode. Specifically, when the applied voltage was 1.3V, a single cell with configuration of Ni-BNCYb|BNCYb|PBCC exhibited current density of 1.8 A cm⁻² at 600° C. under electrolysis conditions.

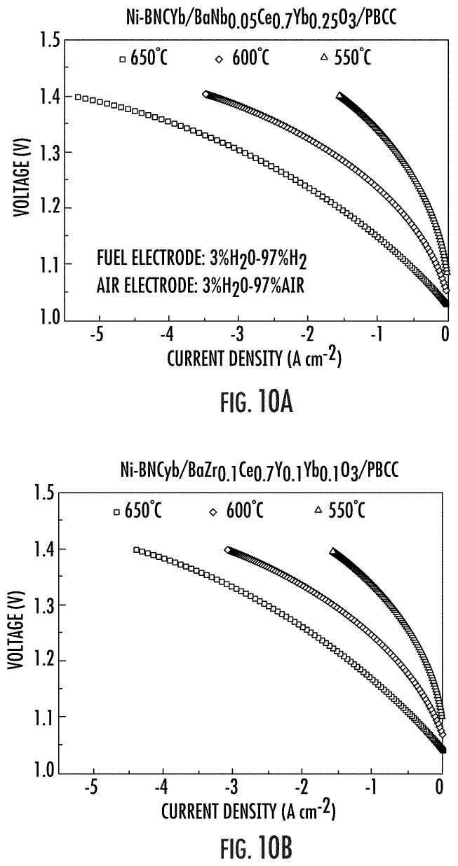

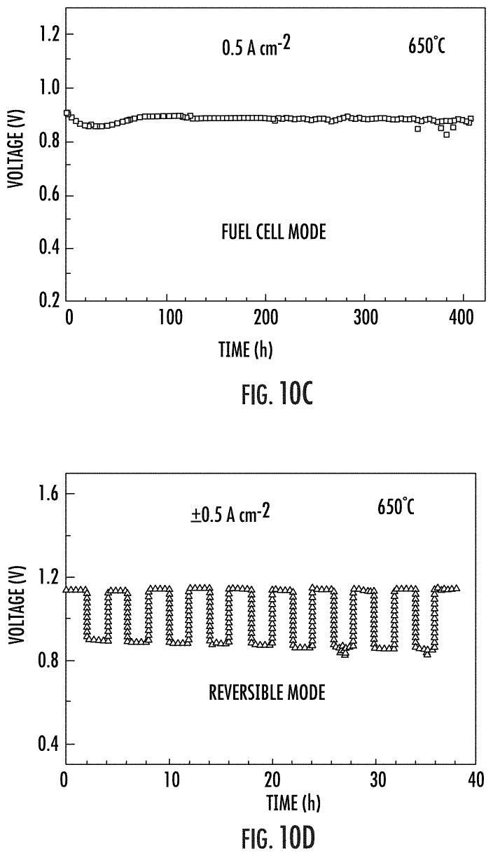

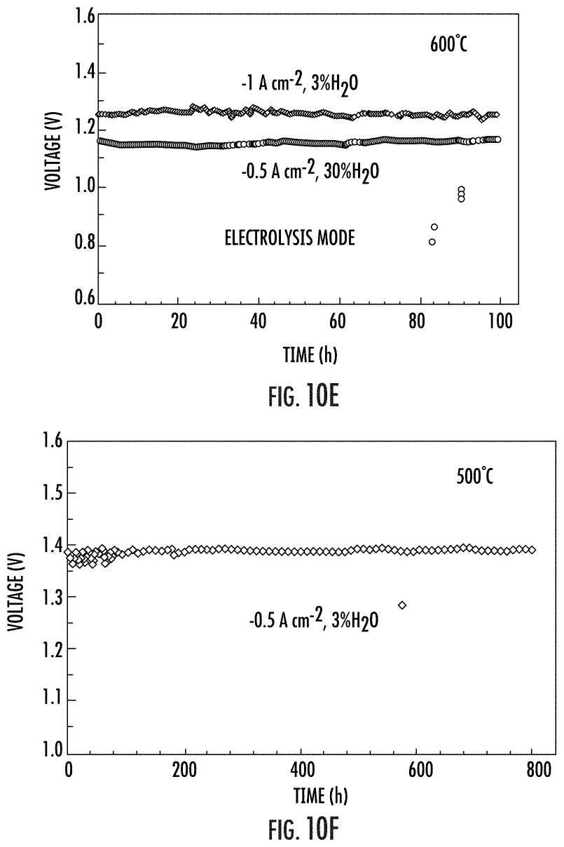

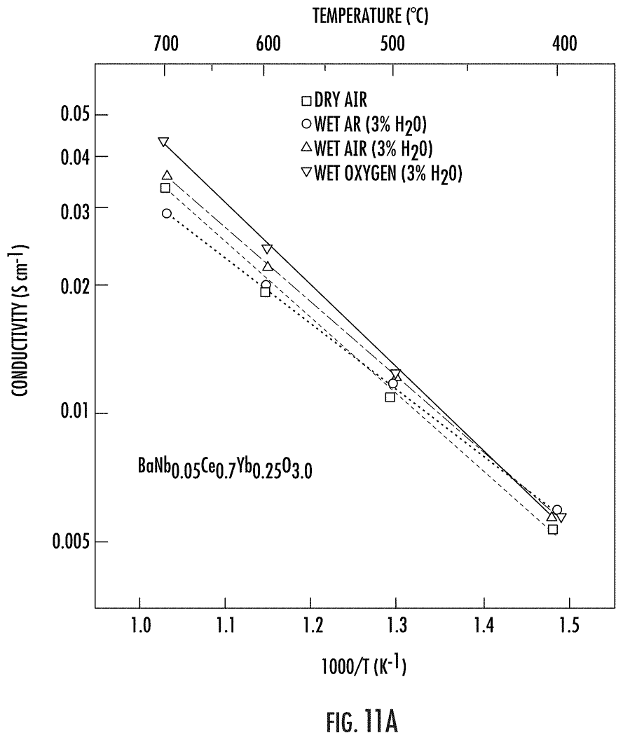

FIG. 10A depicts the cell performance of Ni-BNCYb/BaNb_{0.05}Ce_{0.7}Yb_{0.25}O_{3-δ}/PBCC under electrolysis cell operating conditions. FIG. 10B depicts the performance Ni-BZCYYb/BaZr_{0.1}Ce_{0.7}Y_{0.1}Yb_{0.1}O_{3-δ}/PBCC single cells under electrolysis cell operating conditions. FIG. 10C indicates the stability of a Ni-BNCYb/BNCYb/PBCC single cell fuel cell mode with H₂ (3% H₂O) in the fuel electrode and ambient air in the air electrode at 0.5 A cm⁻² and 650° C. FIG. 10D indicates the reversible operation of a Ni-BNCYb/BNCYb/PBCC single cell fuel cell: the cell voltage as a function of time when the operating mode was switched between the fuel cell and electrolysis modes (2 h for each mode) at a current density of ±0.5 A cm⁻² and 650° C., while FIG. 10E depicts a Ni-BNCYb/BNCYb/PBCC single cell fuel cell in electrolysis mode at 600° C. with H₂ (3% H₂O) in the fuel electrode and air (3% H₂O) in the air electrode at −1 A cm⁻², and with H₂ (3% H₂O) in the fuel electrode and air (30% H₂O) in the air electrode at −0.5 A cm. FIG. 10F depicts a Ni-BNCYb/BNCYb/PBCC single cell fuel cell electrolysis mode with H₂ (3% H₂O) in the fuel electrode and air (3% H₂O) in the air electrode at −0.5 A cm⁻² and 500° C.

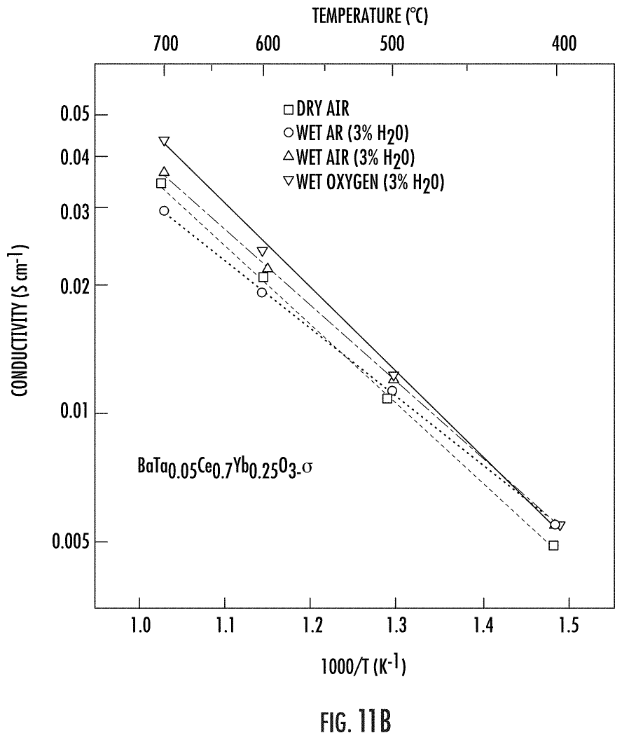

FIG. 11A depicts the conductivity of BNCYb057025 as a function of temperature under various atmospheres. FIG. 11B depicts the conductivity of BTCYb057025 as a function of temperature under various atmospheres.

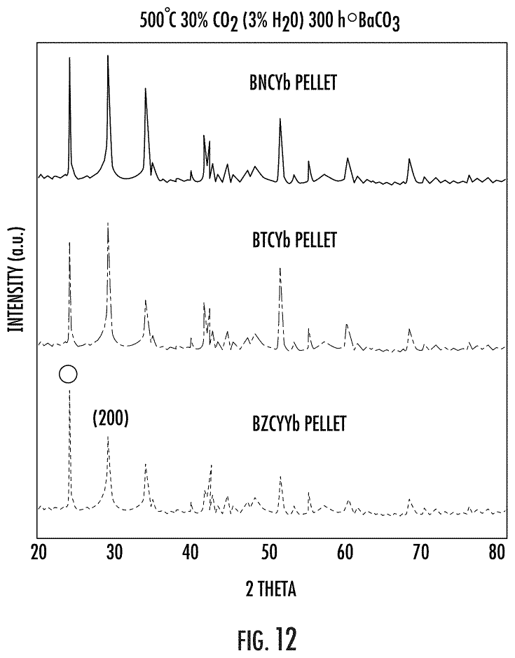

FIG. 12 depicts the full view of XRD patterns of BNCYb, BTCYb, and BZCYYb pellets after exposure to 30% CO₂ and 3% H₂O in Ar at 500° C. for 300 hours.

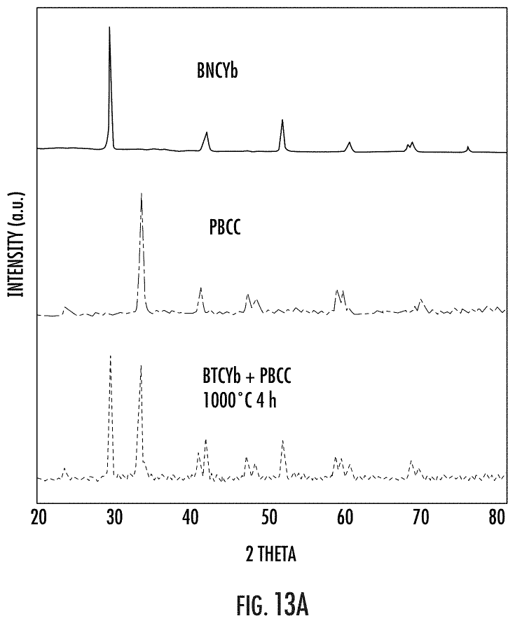

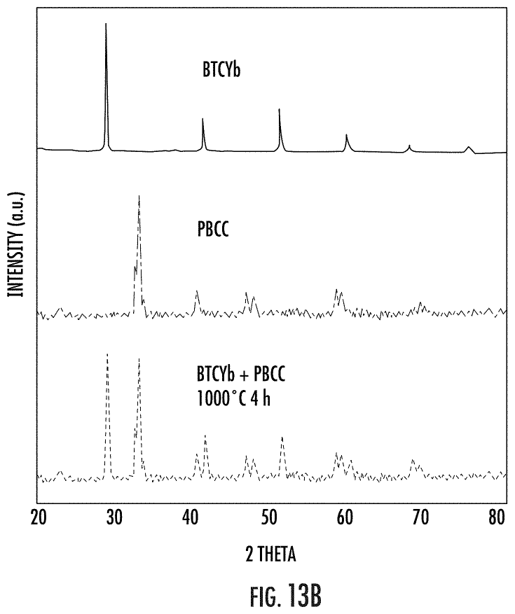

FIG. 13A depicts the XRD pattern of BNCYb after calcining with PBCC at 1000° C. for 4 hours. FIG. 13B depicts the XRD pattern of BTCYb after calcining with PBCC at 1000° C. for 4 hours.

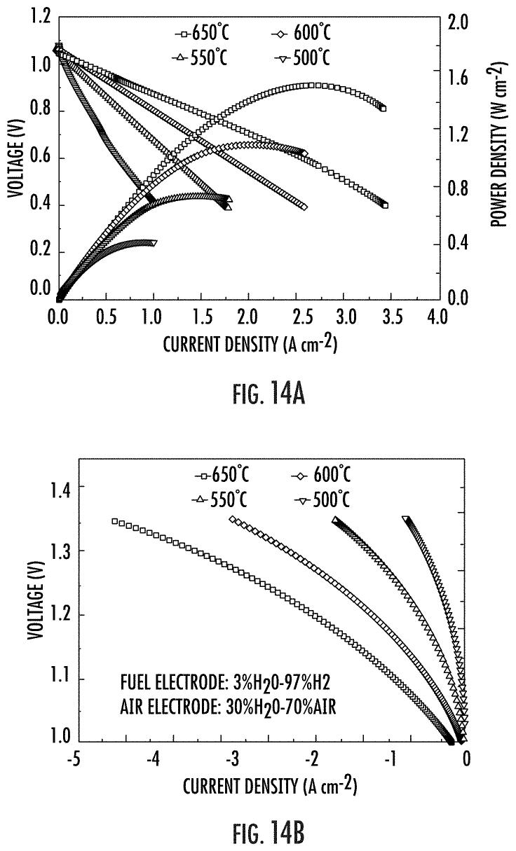

FIG. 14A shows a typical I-V-P curves measured in the fuel cell mode at 500-650° C. with H₂ (3% H₂O) in the fuel electrode and ambient air in the air electrode in the air electrode of the Ni-BTCYb/BTCYb/PBCC single cell. FIG. 14B shows a typical I-V curves measured in the electrolysis mode at 500-650° C. with H₂ (3% H₂O) in the fuel electrode and air (30% H₂O) in the air electrode of the Ni-BTCYb/BTCYb/PBCC single cell.

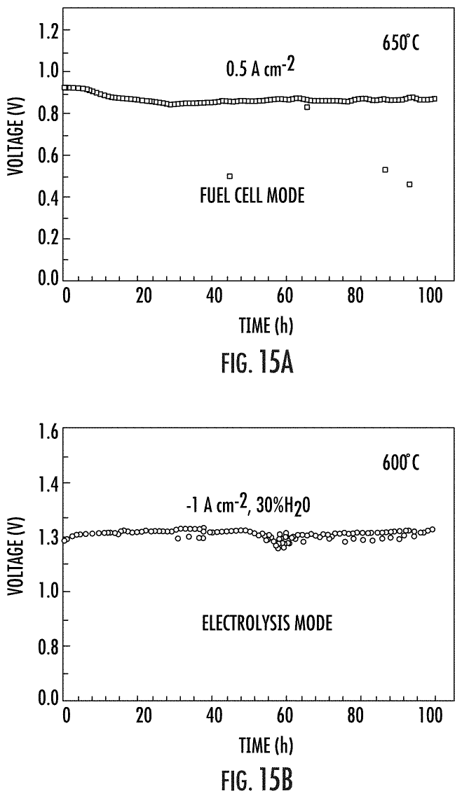

FIG. 15A stows the long-term stability of the Ni-BTCYb/BTCYb/PBCC single cell in) fuel cell mode with H₂ (3% H₂O) in the fuel electrode and ambient air in the air electrode at 0.5 A cm⁻² and 650° C. FIG. 15B shows the long-term stability of the Ni-BTCYb/BTCYb/PBCC single cell in the electrolysis mode with H₂ (3% H₂O) in the fuel electrode and air (30% H₂O) in the air electrode at −1 A cm⁻² and 600° C.

Other advantages which are obvious and which are inherent to the invention will be evident to one skilled in the art. It will be understood that certain features and sub-combinations are of utility and may be employed without reference to other features and sub-combinations. This is contemplated by and is within the scope of the claims. Since many possible embodiments may be made of the invention without departing from the scope thereof, it is to be understood that all matter herein set forth or shown in the accompanying drawings is to be interpreted as illustrative and not in a limiting sense.

What is claimed is:

1. An electrolyte having the formula:
BaMₓCe_{1-x-y}R_{y}O_{3-δ}
wherein M is niobium or tantalum; R is one or more metals having a valence of 3⁺, the index x is from 0 to 1, and the index y is from 0 to 1 wherein if R comprises more than one metal, the sum of the individual y indices is from 0 to 1.

2. The electrolyte according to claim 1, wherein M is niobium.

3. The electrolyte according to claim 1, wherein M is tantalum.

4. The electrolyte according to claim 1, wherein R is chosen from ytterbium, yttrium, dysprosium, scandium, vanadium, chromium, iron, cobalt, lutetium, holmium, or terbium.

5. The electrolyte according to claim 1, wherein R is yttrium.

6. The electrolyte according to claim 1, wherein R is ytterbium.

7. The electrolyte according to claim 1, wherein R is dysprosium.

8. The electrolyte according to claim 1, having the formula BaNb_{0.05}Ce_{0.75}Yb_{0.2}O_{3-δ}, BaNb_{0.05}Ce_{0.7}Yb_{0.25}O_{3-δ}, BaNb_{0.05}Ce_{0.65}Yb_{0.3}O_{3-δ}, BaNb_{0.05}Ce_{0.6}Yb_{0.35}O_{3-δ}, BaNb_{0.05}Ce_{0.55}Yb_{0.4}O_{3-δ}, BaNb_{0.05}Ce_{0.6}Yb_{0.3}O_{3-δ}, BaNb_{0.2}Ce_{0.4}Yb_{0.4}O_{3-δ}, BaNb_{0.05}Ce_{0.7}Y_{0.05}Yb_{0.2}O_{3-δ}, BaNb_{0.05}Ce_{0.65}Y_{0.05}Yb_{0.25}O_{3-δ}, BaNb_{0.05}Ce_{0.6}Y_{0.5}Yb_{0.3}O_{3-δ}, BaNb_{0.1}Ce_{0.6}Y_{0.5}Yb_{0.25}O_{3-δ}, or BaNb_{0.2}Ce_{0.4}Y_{0.5}Yb_{0.35}O_{3-δ}.

9. The electrolyte according to claim 1, having the formula BaNb_{0.05}Ce_{0.75}Y_{0.2}O_{3-δ}, BaNb_{0.05}Ce_{0.7}Y_{0.25}O_{3-δ}, BaNb_{0.05}Ce_{0.65}Y_{0.3}O_{3-δ}, BaNb_{0.05}Ce_{0.6}Y_{0.35}O_{3-δ}, BaNb_{0.05}Ce_{0.55}Y_{0.4}O_{3-δ}, BaNb_{0.05}Ce_{0.5}Y_{0.45}O_{3-δ}, BaNb_{0.1}Ce_{0.6}Y_{0.3}O_{3-δ}, BaNb_{0.2}Ce_{0.4}Y_{0.4}O_{3-δ}, BaNb_{0.05}Ce_{0.7}Y_{0.1}Yb_{0.15}O_{3-δ}, BaNb_{0.05}Ce_{0.65}Y_{0.1}Yb_{0.2}O_{3-δ}, BaNb_{0.05}Ce_{0.6}Y_{0.1}Yb_{0.25}O_{3-δ}, BaNb_{0.1}Ce_{0.6}Y_{0.1}Yb_{0.2}O_{3-δ}, or BaNb_{0.2}Ce_{0.4}Y_{0.1}Yb_{0.3}O_{3-δ}.

10. The electrolyte according to claim 1, having the formula BaNb_{0.05}Ce_{0.75}Dy_{0.2}O_{3-δ}, BaNb_{0.05}Ce_{0.7}Dy_{0.25}O_{3-δ}, BaNb_{0.05}Ce_{0.65}Dy_{0.3}O_{3-δ}, BaNb_{0.05}Ce_{0.6}Dy_{0.35}O_{3-δ}, BaNb_{0.05}Ce_{0.55}Dy_{0.4}O_{3-δ}, BaNb_{0.05}Ce_{0.5}Dy_{0.45}O_{3-δ}, BaNb_{0.2}Ce_{0.6}Dy_{0.3}O_{3-δ}, BaNb_{0.3}Ce_{0.4}Dy_{0.4}O_{3-δ}, BaNb_{0.05}Ce_{0.7}Dy_{0.05}Yb_{0.2}O_{3-δ}, BaNb_{0.05}Ce_{0.65}Dy_{0.05}Yb_{0.25}O_{3-δ}, BaNb_{0.05}Ce_{0.6}Dy_{0.05}Yb_{0.3}O_{3-δ}, BaNb_{0.1}Ce_{0.6}Dy_{0.05}Yb_{0.25}O_{3-δ}, or BaNb_{0.2}Ce_{0.4}Dy_{0.05}Yb_{0.35}O_{3-δ}.

11. The electrolyte according to claim 1, having the formula BaTa_{0.05}Ce_{0.75}Yb_{0.2}O_{3-δ}, BaTa_{0.05}Ce_{0.7}Yb_{0.25}O_{3-δ}, BaTa_{0.05}Ce_{0.65}Yb_{0.3}O_{3-δ}, BaTa_{0.05}Ce_{0.6}Yb_{0.35}O_{3-δ}, BaTa_{0.05}Ce_{0.55}Yb_{0.4}O_{3-δ}, BaTa_{0.05}Ce_{0.5}Yb_{0.45}O_{3-δ}, BaTa_{0.1}Ce_{0.6}Yb_{0.3}O_{3-δ}, BaTa_{0.05}Ce_{0.7}Y_{0.05}Yb_{0.2}O_{3-δ}, BaTa_{0.05}Ce_{0.65}Y_{0.05}Yb_{0.25}O_{3-δ}, BaTa_{0.05}Ce_{0.6}Y_{0.05}Yb_{0.3}O_{3-δ}, or BaTa_{0.1}Ce_{0.6}Y_{0.05}Yb_{0.25}O_{3-δ}.

12. The electrolyte according to claim 1, having the formula BaTa_{0.05}Ce_{0.75}Y_{0.2}O_{3-δ}, BaTa_{0.05}Ce_{0.7}Y_{0.25}O_{3-δ}, BaTa_{0.05}Ce_{0.65}Y_{0.3}O_{3-δ}, BaTa_{0.05}Ce_{0.6}Y_{0.35}O_{3-δ}, BaTa_{0.05}Ce_{0.55}Y_{0.4}O_{3-δ}, BaTa_{0.05}Ce_{0.5}Y_{0.45}O_{3-δ}, BaTa_{0.1}Ce_{0.6}Y_{0.3}O_{3-δ}, BaTa_{0.05}Ce_{0.7}Y_{0.1}Yb_{0.15}O_{3-δ}, BaTa_{0.05}Ce_{0.65}Y_{0.1}Yb_{0.2}O_{3-δ}, or BaTa_{0.05}Ce_{0.6}Y_{0.1}Yb_{0.25}O_{3-δ}.

13. The electrolyte according to claim 1, having the formula BaTa_{0.05}Ce_{0.75}Dy_{0.2}O_{3-δ}, BaTa_{0.05}Ce_{0.7}Dy_{0.25}O_{3-δ}, BaTa_{0.05}Ce_{0.65}Dy_{0.3}O_{3-δ}, BaTa_{0.05}Ce_{0.6}Dy_{0.35}O_{3-δ}, BaTa_{0.05}Ce_{0.55}Dy_{0.4}O_{3-δ}, BaTa_{0.05}Ce_{0.5}Dy_{0.45}O_{3-δ}, BaTa_{0.1}Ce_{0.6}Dy_{0.3}O_{3-δ}, BaTa_{0.05}Ce_{0.7}Dy_{0.05}Yb_{0.2}O_{3-δ}, BaTa_{0.05}Ce_{0.65}Dy_{0.05}Yb_{0.25}O_{3-δ}, or BaTa_{0.1}Ce_{0.6}Dy_{0.05}Yb_{0.25}O_{3-δ}.
